(19) United States
(12) Patent Application Publication
(10) Pub. No.: US 2015/0101055 A1
(43) Pub. Date: Apr. 9, 2015

(54) METHOD, SYSTEM AND TERMINAL DEVICE FOR SCANNING VIRUS

(71) Applicant: Tencent Technology (Shenzhen) Company Limited, Guangdong (CN)

(72) Inventors: Wenliang Tang, Guangdong (CN); Xing Zeng, Guangdong (CN)

(73) Assignee: Tencent Technology (Shenzhen) Company Limited

(21) Appl. No.: 14/568,387

(22) Filed: Dec. 12, 2014

Related U.S. Application Data
(63) Continuation of application No. PCT/CN2014/074814, filed on Apr. 4, 2014.

(30) Foreign Application Priority Data
May 30, 2013 (CN) 201310208250.X

(51) Int. Cl. G06F 21/56

(52) U.S. Cl. CPC G06F 21/562
USPC 726/24

(57) ABSTRACT

A method, a system and a terminal device for virus scanning are described and related to the field of internet technology. The method includes: monitoring whether a terminal device performs a lock screen operation; determining whether a virus scan has been performed on the terminal device during a period from a time at which a security software program is installed to a current time; and if the virus scan has never been performed on the terminal device during the period from the time at which the security software program is installed to the current time, enabling the security software program to perform the virus scan. In the method, the system and the terminal device, a virus can be scanned in time and the efficiency of virus scanning can be relatively improved.

### CROSS REFERENCE TO RELATED APPLICATIONS

This application is a U.S. continuation application under 35 U.S.C. §111(a) claiming priority under 35 U.S.C. §§120 and 365(c) to International Application No. PCT/CN2014/074814 filed Apr. 4, 2014, which claims the priority benefit of Chinese Patent Application No. 201310208250.X filed May 30, 2013, the contents of which are incorporated by reference herein in their entirety for all intended purposes.

### FIELD

The disclosure relates to the field of internet technology, and particularly to a method, a system and a terminal device for scanning virus.

### BACKGROUND

This section provides background information related to the present disclosure which is not necessarily prior art.

More and more software appears in a smart phone with the development of the smart phone technology. However, a virus (i.e. a malware) may be installed in some percentage of the software to promote an advertisement anonymously, to download software without authority, and even to charge secretly, which becomes a potential threat by stealing network traffic or charge from the smart phone. To eliminate the threat existed in the smart phone, a security software program can be provided to perform a virus scan. While in practical applications, a user needs to enable the security software program in the smart phone in person, and needs to manually perform the virus scan to find the virus. However, in practice, the user usually performs the virus scan in a long interval. Thus, the virus cannot be scanned in time, and an efficiency of virus scanning also can be reduced.

### SUMMARY

Exemplary embodiments of the present invention provide a method, a system and a terminal device for scanning virus, in which a virus can be scanned in time and the efficiency of virus scanning can be improved.

One embodiment of the present invention provides a method for scanning virus, comprising: monitoring whether a terminal device performs a lock screen operation; if the terminal device performs the lock screen operation, determining whether a virus scan has been performed on the terminal device during a period from a time at which a security software program is installed to a current time; and if the virus scan has never been performed on the terminal device during the period from the time at which the security software program is installed to the current time, enabling the security software program to perform the virus scan.

Another embodiment of the present invention provides a system for scanning virus, comprising: a monitoring unit configured to monitor whether a terminal device performs a lock screen operation; a first determining unit configured to determinate whether a virus scan has been performed on the terminal device during a period from a time at which a security software program is installed to a current time, when the monitoring unit detects the terminal device performs the lock screen operation; and a scan enabling unit configured to enable the security software program to perform the virus scan when the first determining unit determines that the virus scan has never been performed on the terminal device during the period from the time at which the security software program is installed to the current time.

Yet another embodiment of the present invention provides a terminal device, comprising a system for virus scanning described above.

In exemplary embodiments of the present invention, when a lock screen operation performed on a terminal device is detected, it can be determined whether a virus scan has been performed on the terminal device during a period from a time at which a security software program is installed to a current time. If the virus scan has never been performed on the terminal device during the period from the time at which the security software program is installed to the current time, the security software program can be enabled to perform the virus scan. The terminal device performs the lock screen operation automatically or under control of the user, which may cause the terminal device performing the lock screen operation frequently. Thus, when the terminal device performs the lock screen operation, it can be taken as a trigger condition. A virus can be scanned in time and an efficiency of virus scanning can be relatively improved.

### BRIEF DESCRIPTION OF THE DRAWINGS

In order to illustrate technical solutions according to embodiments of the disclosure, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of an example of a method for scanning virus according to various embodiments;

FIG. 2 is a flowchart of another example of a method for scanning virus according to various embodiments;

FIG. 3 is a structure diagram of an example of a system for scanning virus according to various embodiments;

FIG. 4 is a structure diagram of another example of a system for scanning virus according to various embodiments;

FIG. 5 is a structure diagram of an example of a terminal device according to various embodiments.

### DETAILED DESCRIPTION OF ILLUSTRATED EMBODIMENTS

Technical solutions in embodiments of the present invention will be illustrated clearly and entirely with the aid of the drawings in the embodiments of the invention. It is apparent that the illustrated embodiments are only some embodiments of the invention instead of all of them. Other embodiments that a person having ordinary skills in the art obtains based on the illustrated embodiments of the invention without paying any creative work should all be within the protection scope sought by the present invention.

A method, a system and a terminal device for scanning virus disclosed in exemplary embodiments can scan a virus in time and relatively improve the efficiency of virus scanning. The illustrations for the method, the system and the terminal device will be described respectively as below.

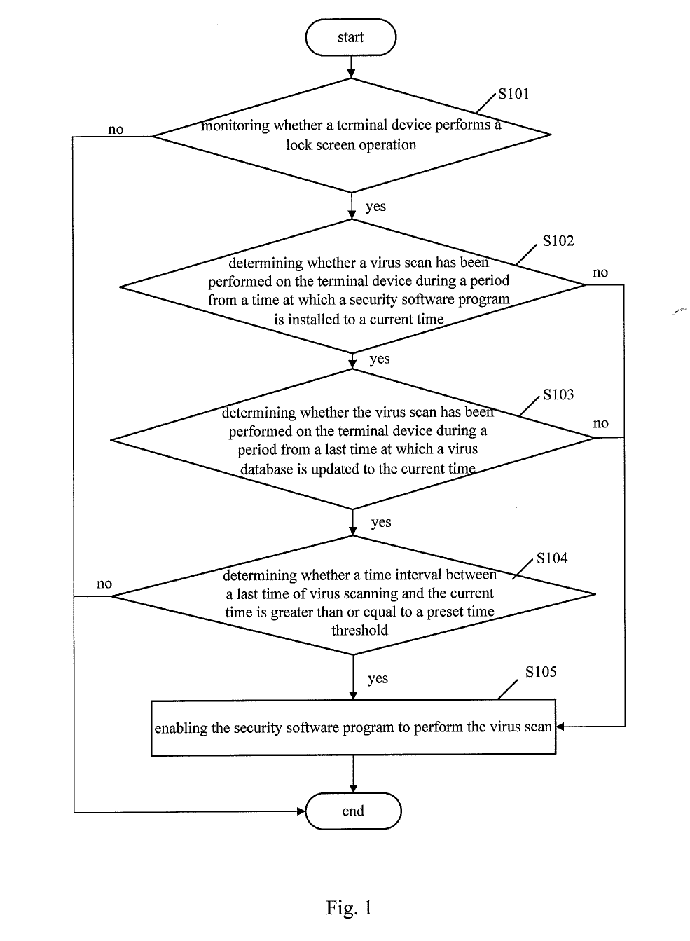

Referring to FIG. 1, it is a flowchart of an example of a method for scanning virus according to various embodiments. The method can be applied for a terminal device such as a smart phone (e.g., an Android phone, an iOS phone, etc.), a tablet computer, a portable computer, a mobile internet device (MID), a personal computer, and so on. The method may include the following steps.

Step S101 is: monitoring whether a terminal device performs a lock screen operation. If the lock screen operation performed by the terminal device is detected, step S102 can be executed; if the lock screen operation performed by the terminal device is not detected, the flow may come to the end.

In one embodiment of the invention, the terminal device can perform the lock screen operation automatically or under control of the user. For example, when the user has not actively use the terminal device for 5 minutes, 10 minutes, 15 minutes, or the like, the terminal device can perform the lock screen operation automatically; or the terminal device can perform the lock screen operation when receiving the control command from the user.

Step S102 is: if the terminal device performs the lock screen operation, determining whether a virus scan has been performed on the terminal device during a period from a time at which a security software program is installed to a current time. If the virus scan has never been performed on the terminal device during the period from the time at which the security software program is installed to the current time, step S105 can be executed; if the virus scan has been performed on the terminal device during the period from the time at which the security software program is installed to the current time, step S103 can be executed.

In one embodiment of the invention, the terminal device can record the time at which the security software program is installed after it may accomplish the installation of the security software program. And then, when the lock screen operation performed by the terminal device is detected, it may be determined whether the virus scan has been performed on the terminal device during the period from the time at which the security software is installed to the current time.

Step 103 is: if determining that the virus scan has been performed on the terminal device during the period from the time at which the security software program is installed to the current time, determining whether the virus scan has been performed on the terminal device during a period from a last time at which a virus database is updated to the current time. If the virus scan has never been performed on the terminal device during the period from the last time at which the virus database is updated to the current time, step S105 can be executed; if the virus scan has been performed on the terminal device during the period from the last time at which the virus database is updated to the current time, step S104 can be executed.

In one embodiment of the invention, the terminal device can record the last time at which the virus database is updated. Then, when it is determined that the virus scan has been performed during the period from the time at which the security software program is installed to the current time, it may be determined whether the virus scan has been performed during the period from the last time at which the virus database is updated to the current time.

Step S104 is: if determining that the virus scan has been performed on the terminal device during the period from the last time at which the virus database is updated to the current time, determining whether a time interval between a last time of virus scanning and the current time is greater than or equal to a preset time threshold. If the time interval between the last time of virus scanning and the current time is greater than or equal to the preset time threshold, step S105 can be executed; if the time interval between the last time of virus scanning and the current time is less than the preset time threshold, the flow may come to the end.

In one embodiment of the invention, the terminal device can record the last time of virus scanning. Then, when it is determined that the virus scan has been performed during the period from the last time at which the virus database is updated to the current, it may be determined whether the time interval between the last time of virus scanning and the current is greater than or equal to the preset time threshold (e.g. 1 day, 3 days, or 5 days).

Step S105 is: enabling the security software program to perform the virus scan.

In practical applications, it may consume a certain resource of the terminal device to enable the security software program to perform the virus scan. While in one embodiment of the invention, virus scanning can only be triggered at the condition when the screen of the terminal device is locked. Thus the running speed of the terminal device controlled by the user may not be influenced.

In one embodiment of the invention, the security software program can also perform the virus scan at the background, which means a security software interface may not need to be enabled. Thus, the consumed resource of the terminal device during the virus scan can be reduced; for example, the terminal device may consume power, etc.

In one embodiment of the invention, the method shown in FIG. 1 can further include the following step: outputting a virus scan result, wherein the virus scan result includes the number of viruses and a prompt message which is used to prompt operations to be performed on a virus, the operations including a clearing operation and an ignoring operation.

When the user selects the clearing operation, the terminal device may clear a detected virus; when the user selects the ignoring operation, the terminal device may ignore the detected virus.

In exemplary embodiments of the present invention, when a lock screen operation performed on a terminal device is detected, it may be determined whether a virus scan has been performed on the terminal device during a period from a time at which a security software program is installed to a current time. If the virus scan has never been performed on the terminal device during the period from the time at which the security software program is installed to the current time, the security software program can be enabled to perform the virus scan. The terminal device can perform the lock screen operation automatically or under control of the user, which may cause the terminal device performing the lock screen operation frequently. Thus, when the terminal device performs the lock screen operation, it can be taken as a trigger condition. A virus can be scanned in time and the efficiency of virus scanning can be relatively improved.

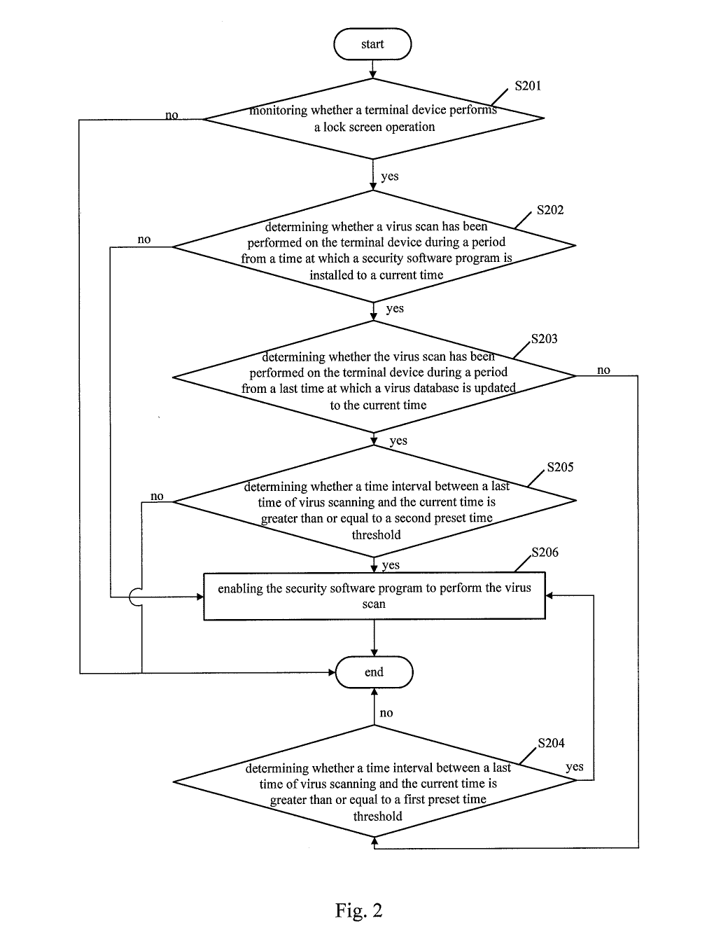

Referring to FIG. 2, it is a flowchart of another example of a method for scanning virus according to various embodiments. The method can be applied for a terminal device such as a smart phone (e.g., an Android phone, an iOS phone, etc.), a tablet computer, a portable computer, a mobile internet device (MID), a personal computer, and so on. The method may include the following steps.

Step S201 is: monitoring whether a terminal device performs a lock screen operation. If the lock screen operation performed by the terminal device is detected, step S202 can be executed; if the lock screen operation performed by the terminal device is not detected, the flow may come to the end.

In one embodiment of the invention, the terminal device can perform the lock screen operation automatically or under control of the user. For example, when the user has not actively use the terminal device for 5 minutes, 10 minutes, 15 minutes, or the like, the terminal device can perform the lock screen operation automatically; or the terminal device can perform the lock screen operation when receiving the control command from the user.

Step S202 is: if the terminal device performs the lock screen operation, determining whether a virus scan has been performed on the terminal device during a period from a time at which a security software program is installed to a current time. If the virus scan has never been performed on the terminal device during the period from the time at which the security software program is installed to the current time, step S206 can be executed; if the virus scan has been performed on the terminal device during the period from the time at which the security software program is installed to the current time, step S203 can be executed.

In one embodiment of the invention, the terminal device can record the time at which the security software program is installed after it may accomplish the installation of the security software program. And then, when the lock screen operation performed by the terminal device is detected, it may be determined whether the virus scan has been performed on the terminal device during the period from the time at which the security software is installed to the current time.

Step S203 is: if determining that the virus scan has been performed on the terminal device during the period from the time at which the security software program is installed to the current time, determining whether the virus scan has been performed on the terminal device during a period from a last time at which a virus database is updated to the current time. If the virus scan has never been performed on the terminal device during the period from the last time at which the virus database is updated to the current time, step S204 can be executed; if the virus scan has been performed on the terminal device during the period from the last time at which the virus database is updated to the current time, step S205 can be executed.

In one embodiment of the invention, the terminal device can record the last time at which the virus database is updated. Then, when it is determined that the virus scan has been performed during the period from the time at which the security software program is installed to the current time, it may be determined whether the virus scan has been performed during the period from the last time at which the virus database is updated to the current time.

Step S204 is: determining whether a time interval between a last time of virus scanning and the current time is greater than or equal to a first preset time threshold (e.g. 1 day). If the time interval between the last time of virus scanning and the current time is greater than or equal to the first preset time threshold, step S206 can be executed; if the time interval between the last time of virus scanning and the current time is less than the first preset time threshold, the flow may come to the end.

Step S205 is: if determining that the virus scan has been performed on the terminal device during the period from the last time at which the virus database is updated to the current time, determining whether a time interval between a last time of virus scanning and the current time is greater than or equal to a second preset time threshold, wherein the second preset time threshold is greater than the first preset time threshold. If the time interval between the last time of virus scanning and the current time is greater than or equal to the second preset time threshold, step S206 can be executed; if the time interval between the last time of virus scanning and the current time is less than the second preset time threshold, the flow may come to the end.

In one embodiment of the invention, the terminal device can record the last time of virus scanning. Then, when it is determined that the virus scan has been performed during the period from the last time at which the virus database is updated to the current, it may be determined whether the time interval between the last time of virus scanning and the current is greater than or equal to the second preset time threshold (e.g. 7 days).

Step S206 is: enabling the security software program to perform the virus scan.

In one embodiment of the invention, the security software program can also perform the virus scan at the background, which means a security software interface may not need to be enabled. Thus, the consumed resource of the terminal device during the virus scan can be reduced; for example, the terminal device may consume power, etc.

In one embodiment of the invention, the method shown in FIG. 2 can further include: outputting a virus scan result, wherein the virus scan result includes the number of viruses and a prompt message which is used to prompt operations to be performed on a virus, the operations including a clearing operation and an ignoring operation.

When the user selects the clearing operation, the terminal device may clear a detected virus; when the user selects the ignoring operation, the terminal device may ignore the detected virus.

In the method shown in FIG. 2, when the terminal device performs the lock screen operation, it can be taken as a trigger condition. A virus can be scanned in time and the efficiency of virus scanning can be relatively improved.

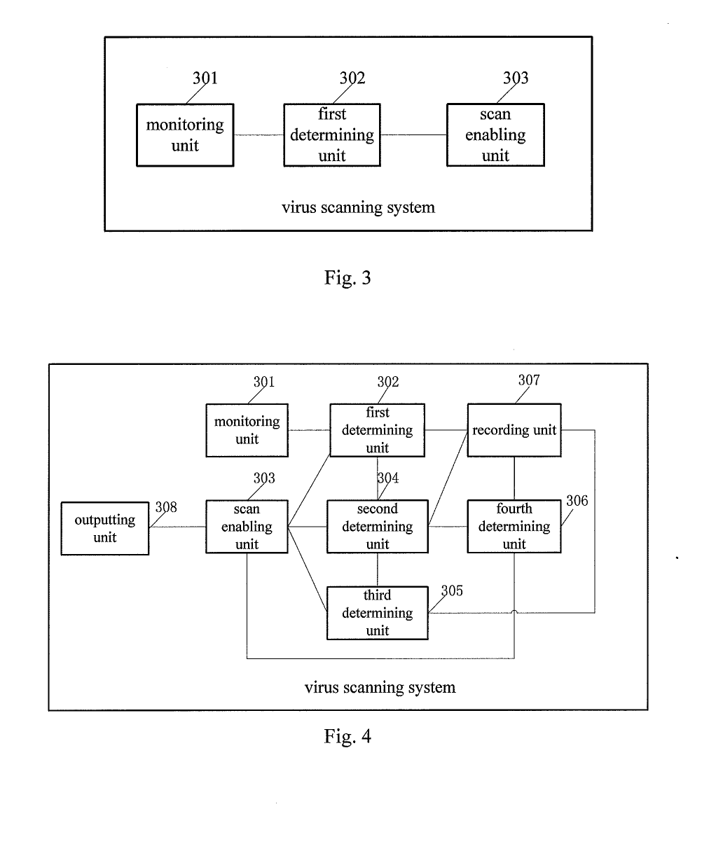

Referring to FIG. 3, it a structure diagram of an example of a system for scanning virus according to various embodiments. The system can be applied for a terminal device such as a smart phone (e.g., an Android phone, an iOS phone, etc.), a tablet computer, a portable computer, a mobile internet device (MID), a personal computer, and so on. The system may include: a monitoring unit 301 configured to monitor whether a terminal device performs a lock screen operation; a first discriminating unit 302 configured to determine whether a virus scan has been performed on the terminal device during a period from a time at which a security software program is installed to a current time, when the monitoring unit 301 detects that the terminal device performs the lock screen operation; and a scan enabling unit 303 configured to enable the security software program to perform the virus scan when the first determining unit 302 determines that the virus scan has never been performed on the terminal device during the period from the time at which the security software program is installed to the current time.

In the system for virus scanning shown in FIG. 3, when the monitoring unit 301 detects that the terminal device performs the lock screen operation, the first determining unit 302 can determine whether the virus scan has been performed on the terminal device during the period from the time at which the security software program is installed to the current time. If the virus scan has never been performed on the terminal device, the scan enabling unit 303 can enable the security software program to perform the virus scan. In one embodiment of the invention, the terminal device can perform the lock screen operation automatically or under control of the user, which may cause the terminal device performing the lock screen operation frequently. Thus, in the system shown in FIG. 3, when the terminal device performs the lock screen operation, it can be taken as a trigger condition. A virus can be scanned in time and the efficiency of virus scanning can be relatively improved.

Referring to FIG. 4, it is a structure diagram of another example of a system for scanning virus according to various embodiments. The system shown in FIG. 4 can be obtained by optimizing the system shown in FIG. 3. The system shown in FIG. 4 may include the monitoring unit 301, the first determining unit 302 and the scan enabling unit 303, it may further include: a second determining unit 304 configured to determine whether the virus scan has been performed on the terminal device during a period from a last time at which a virus database is updated to the current time, when the first determining unit 302 determines that the virus scan has been performed on the terminal device during the period from the time at which the security software program is installed to the current time. Correspondingly, the scan enabling unit 303 can be also configured to enable the security software program to perform the virus scan when the second determining unit 304 determines that the virus scan has never been performed on the terminal device during the period from the last time at which the virus database is updated to the current time.

In one embodiment of the invention, the system shown in FIG. 4 may further include: a third determining unit 305 configured to determine whether a time interval between the last time at which the virus database is updated and the current time is greater than or equal to a first preset time threshold, when the second determining unit 304 determines that the virus scan has never been performed on the terminal device during the period from the last time at which the virus database is updated to the current time. Correspondingly, the scan enabling unit 303 can also be configured to enable the security software program to perform the virus scan when the third determining unit 305 determines that the time interval between the last time at which the virus database is updated and the current time is greater than or equal to the first preset time threshold.

In one embodiment of the invention, the system shown in FIG. 4 further include: a fourth determining unit 306 configured to determine whether a time interval between a last time of virus scanning and the current time is greater than or equal to a second preset time threshold (e.g. 7 days), when the second determining unit determines that the virus scan has been performed on the terminal device during the period from the last time at which the virus database is updated to the current time, wherein the second preset time threshold is greater than the first preset time threshold. Correspondingly, the scan enabling unit 303 can also be configured to enable the security software program to perform the virus scan when the fourth determining unit 306 determines that the time interval between the last time of virus scanning and the current time is greater than or equal to the second preset time threshold.

In one embodiment of the invention, the system shown in FIG. 4 can further include: a recording unit 307 configured to record the time at which the security software program is installed, the last time at which the virus database is updated, and the last time of virus scanning.

In one embodiment of the invention, the system shown in FIG. 4 can further include: an outputting unit 308 configured to output a virus scan result, wherein the virus scan result includes the number of viruses and a prompt message which is used to prompt operations to be performed on a virus, the operations including a clearing operation and an ignoring operation.

In the system shown in FIG. 4, when the terminal device performs the lock screen operation, it can be taken as a trigger condition. A virus can be scanned in time and the efficiency of virus scanning can also be improved.

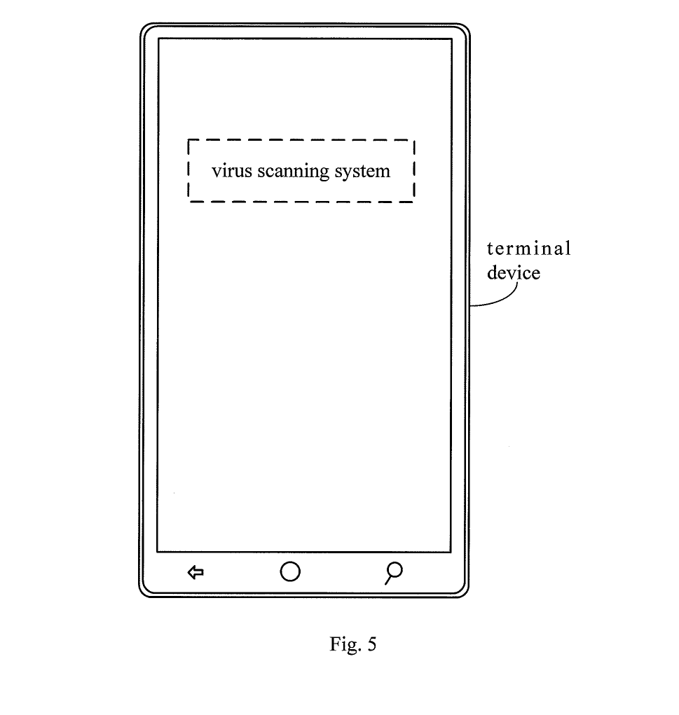

Referring to FIG. 5, it is a structure diagram of an example of a terminal device according to various embodiments. The terminal device can include but not limited to: a smart phone (e.g., an Android phone, an iOS phone, etc.), a tablet computer, a portable computer, a mobile internet device (MID), a personal computer, etc. As shown in FIG. 5, the terminal device may include a system for scanning virus shown in FIG. 3 or FIG. 4. The terminal device can scan a virus in time and also improve the efficiency of virus scanning.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The above descriptions are some exemplary embodiments of the invention, and should not be regarded as limitation to the scope of related claims. A person having ordinary skills in a relevant technical field will be able to make improvements and modifications within the spirit of the principle of the invention. The improvements and modifications should also be incorporated in the scope of the claims attached below.

What is claimed is:

1. A method for scanning virus, comprising:
monitoring whether a terminal device performs a lock screen operation;
determining whether a virus scan has been performed on the terminal device during a period from a time at which a security software program is installed to a current time, if the terminal device performs the lock screen operation; and
enabling the security software program to perform the virus scan, if the virus scan has never been performed on the terminal device during the period from the time at which the security software program is installed to the current time.

2. The method of claim 1, further comprising:
determining whether the virus scan has been performed on the terminal device during a period from a last time at which a virus database is updated to the current time, if determining that the virus scan has been performed on the terminal device during the period from the time at which the security software program is installed to the current time; and
enabling the security software program to perform the virus scan, if the virus scan has never been performed on the terminal device during the period from the last time at which the virus database is updated to the current time.

3. The method of claim 2, further comprising:
determining whether a time interval between the last time at which the virus database is updated and the current time is greater than or equal to a first preset time threshold, if the virus scan has never been performed on the terminal device during the period from the last time at which the virus database is updated to the current time; and
enabling the security software program to perform the virus scan, if the time interval between the last time at which the virus database is updated and the current time is greater than or equal to the first preset time threshold.

4. The method of claim 3, further comprising:
determining whether a time interval between a last time of virus scanning and the current time is greater than or equal to a second preset time threshold, if determining that the virus scan has been performed on the terminal device during the period from the last time at which the virus database is updated to the current time, wherein the second preset time threshold is greater than the first preset time threshold; and
enabling the security software program to perform the virus scan, if the time interval between the last time of virus scanning and the current time is greater than or equal to the second preset time threshold.

5. The method of claim 4, further comprising:
recording the time at which the security software program is installed, the last time at which the virus database is updated, and the last time of virus scanning.

6. The method of claim 1, further comprising:
outputting a virus scan result, wherein the virus scan result comprises the number of viruses and a prompt message configured to prompt operations to be performed on a virus, the operations comprise a clearing operation and an ignoring operation.

7. The method of claim 2, further comprising:
outputting a virus scan result, wherein the virus scan result comprises the number of viruses and a prompt message configured to prompt operations to be performed on a virus, the operations comprise a clearing operation and an ignoring operation.

8. The method of claim 3, further comprising:
outputting a virus scan result, wherein the virus scan result comprises the number of viruses and a prompt message configured to prompt operations to be performed on a virus, the operations comprise a clearing operation and an ignoring operation.

9. The method of claim 4, further comprising:
outputting a virus scan result, wherein the virus scan result comprises the number of viruses and a prompt message configured to prompt operations to be performed on a virus, the operations comprise a clearing operation and an ignoring operation.

10. The method of claim 5, further comprising:
outputting a virus scan result, wherein the virus scan result comprises the number of viruses and a prompt message configured to prompt operations to be performed on a virus, the operations comprise a clearing operation and an ignoring operation.

11. A system for scanning virus, comprising:
a monitoring unit configured to monitor whether a terminal device performs a lock screen operation;
a first determining unit configured to determine whether a virus scan has been performed on the terminal device during a period from a time at which a security software program is installed to a current time, when the monitoring unit detects that the terminal device performs the lock screen operation; and
a scan enabling unit configured to enable the security software program to perform the virus scan when the first determining unit determines that the virus scan has never been performed on the terminal device during the period from the time at which the security software program is installed to the current time.

12. The system of claim 11, further comprising:
a second determining unit configured to determine whether the virus scan has been performed on the terminal device during a period from a last time at which a virus database is updated to the current time, when the first determining unit determines that the virus scan has been performed on the terminal device during the period from the time at which the security software program is installed to the current time;
wherein the scan enabling unit is also configured to enable the security software program to perform the virus scan when the second determining unit determines that the virus scan has never been performed on the terminal device during the period from the last time at which the virus database is updated to the current time.

13. The system of claim 12, further comprising:
a third determining unit configured to determine whether a time interval between the last time at which the virus database is updated and the current time is greater than or equal to a first preset time threshold, when the second determining unit determines that the virus scan has never been performed on the terminal device during the period from the last time at which the virus database is updated to the current time;
wherein the scan enabling unit is also configured to enable the security software program to perform the virus scan when the third determining unit determines that the time interval between the last time at which the virus database is updated and the current time is greater than or equal to the first preset time threshold.

14. The system of claim 13, further comprising:
a fourth determining unit configured to determine whether a time interval between a last time of virus scanning and the current time is greater than or equal to a second preset time threshold, when the second determining unit determines that the virus scan has been performed on the terminal device during the period from the last time at which the virus database is updated to the current time, wherein the second preset time threshold is greater than the first preset time threshold;
wherein the scan enabling unit is also configured to enable the security software program to perform the virus scan when the fourth determining unit determines that the time interval between the last time of virus scanning and the current time is greater than or equal to the second preset time threshold.

15. The system of claim 14, further comprising:
a recording unit configured to record the time at which the security software program is installed, the last time at which the virus database is updated, and the last time of virus scanning.

16. The system of claim 11, further comprising:
an outputting unit configured to output a virus scan result, wherein the virus scan result comprises the number of viruses and a prompt message configured to prompt operations to be performed on a virus, the operations comprising a clearing operation and an ignoring operation.

17. The system of claim 12, further comprising:
an outputting unit configured to output a virus scan result, wherein the virus scan result comprises the number of viruses and a prompt message configured to prompt operations to be performed on a virus, the operations comprising a clearing operation and an ignoring operation.

18. The system of claim 13, further comprising:
an outputting unit configured to output a virus scan result, wherein the virus scan result comprises the number of viruses and a prompt message configured to prompt operations to be performed on a virus, the operations comprising a clearing operation and an ignoring operation.

19. The system of claim 14, further comprising:
an outputting unit configured to output a virus scan result, wherein the virus scan result comprises the number of viruses and a prompt message configured to prompt operations to be performed on a virus, the operations comprising a clearing operation and an ignoring operation.

20. The system of claim 15, further comprising:
an outputting unit configured to output a virus scan result, wherein the virus scan result comprises the number of viruses and a prompt message configured to prompt operations to be performed on a virus, the operations comprising a clearing operation and an ignoring operation.
